(19) United States
(12) Patent Application Publication
(10) Pub. No.: US 2008/0307653 A1
(43) Pub. Date: Dec. 18, 2008

(54) Manually Actuable Liquid Dispensing Razor

(76) Inventor: Christopher J. Wattam, London (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/137,991

(22) Filed: Jun. 12, 2008

Related U.S. Application Data
(60) Provisional application No. 60/934,238, filed on Jun. 12, 2007.

(51) Int. Cl. B26B 19/38

(52) U.S. Cl. 30/41

(57) ABSTRACT

A shaving razor suitable for dispensing a fluid during a shaving experience, said razor comprising: a handle including a proximal end and a distal end wherein said handle comprises a cavity; an adapter head joined to said handle at the proximal end wherein said adapter head comprises a manually-actuated pump and a cartridge connection yoke; a razor cartridge comprising a blade and wherein a feeding channel is directed from said pump to a disposal point within said cartridge for dispensing said fluid; and wherein said cartridge is releasably engaged with cartridge connection yoke of said adapter head.

### CROSS REFERENCE TO RELATED APPLICATION

This application claims the benefit of U.S. Provisional Application No. 60/934,238, filed Jun. 12, 2007.

### FIELD OF THE INVENTION

This invention relates to a manually actuable liquid dispensing razor.

### BACKGROUND OF THE INVENTION

This invention relates to the field of wet shaving which is the process where a razor with one or more sharpened blades is moved along skin to cut hair. When a consumer engages in the wet shaving experience, it is typical to apply a skin preparation, e.g., shaving soap, shaving cream, shaving gel, skin conditioning foam, etc., via a brush or manual application prior to movement of the razor along the skin's surface. Most consumers find this type of preparation to be rather inconvenient because of the need for multiple shaving products, e.g., a wet shaving razor and a skin preparation product, as well as the undesirable necessity for multiple application steps during the wet shaving process. This multi-step process also results in an overall extended shaving experience which most consumers do not prefer given typical morning hygiene routines. It may, however, be desirable sometimes to apply fluids of other kinds to the skin before, during, or after shaving. It has been found that especially in the case of males who shave facial hair, it is important to provide a shave preparation of some sort prior to shaving in order to adequately hydrate the coarser facial hairs to allow for an easier and closer shave.

In the past, there have been a number of wet shaving product configurations that include a system for conveying a shaving preparation during shaving, e.g. a lubricating fluid, from a reservoir incorporated in the razor structure in the form of a hollowed out razor handle or even an aerosol can that acts as a razor handle, to a dispensing location near the head of the razor. A number of more recent wet shaving razors have cartridges that are movably mounted, in particular pivotable, relative to the handle structures on which they are mounted either permanently, in the case of disposable safety razors intended to be discarded when the blade or blades have become dulled, or detachably to allow replacement of the blade unit on a reusable handle structure. An exemplary razor of this sort is disclosed in U.S. Pat. No. 6,789,321 issued to Simms on Sep. 14, 2004 or U.S. Pat. No. 7,127,817 issued to Orloff et al. on Oct. 31, 2006. Many of these types of razors that are capable of conveying a liquid to the skin surface are unfortunately plagued by a number of problems. For instance, the innerworkings of the razors tend to be cost prohibitive from a large scale manufacturing standpoint. Additionally, there are safety and performance issues that are constantly experience due to microbial growth with the reservoir due to the continued exposure of a portion of the remaining liquid to air. This exposure of the liquid to air may oftentimes result in clogging of the razor's innerworkings by the liquid resulting in a nonperforming shaving product.

### SUMMARY OF THE INVENTION

The present invention relates to a shaving razor suitable for dispensing a fluid during a shaving experience, the razor comprising:
a. a handle including a proximal end and a distal end wherein said handle comprises a cavity;
b. an adapter head joined to said handle at the proximal end wherein said adapter head comprises a manually-actuated pump and a cartridge connection yoke;
c. a razor cartridge comprising a blade and wherein a feeding channel is directed from said pump to a disposal point within said cartridge for dispensing said fluid; and
wherein said cartridge is releasably engaged with cartridge connection yoke of said adapter head.

The present invention also relates to an an implement comprising:
a. a handle including a proximal end and a distal end wherein said handle comprises a cavity;
b. an adapter head joined to said handle at the proximal end wherein said adapter head has a proximal end and distal end and comprises
   1) a manually-actuated pump placed between the proximal and distal ends of said head,
   2) a cartridge connection yoke disposed at the proximal end of said head, and
   3) an attached feeding channel
   wherein said cartridge connection yoke of said adapter head is equipped to releasably engage a razor cartridge and a cartridge feeding channel of said cartridge.

### BRIEF DESCRIPTION OF THE DRAWINGS

FIG. 1 shows a top perspective view of a razor of the present invention.

FIG. 2 shows a bottom view of the cartridge of the razor of FIG. 1.

### DETAILED DESCRIPTION OF THE INVENTION

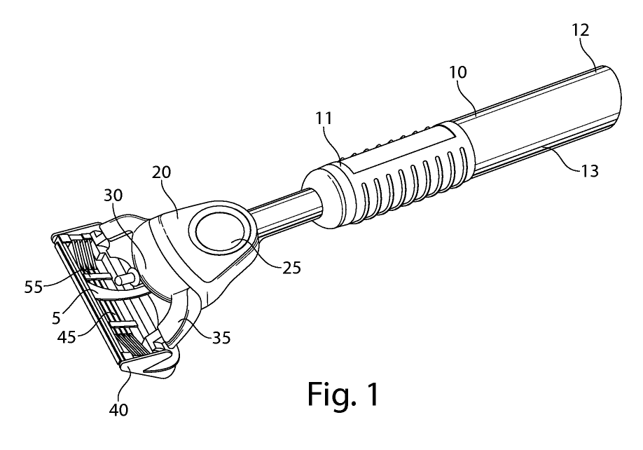

The razor shown in FIG. 1 includes a handle 10 that includes a proximal end 11 and a distal end 12 and the handle comprises a cavity 13. Attached or joined to the handle 10 at the proximal end is an adapter head 20. The adapter head 20 comprises a manually-actuated pump 25 from which extends a cartridge connection yoke 30. This yoke 30 comprises at least one arm 35 that extends to connect to a razor cartridge 40. The yoke 30 releasably engages the razor cartridge 40 which further includes one or more blades 45. The cartridge 40 also includes a feeding channel 50 that leads from the pump 25 to a disposal point 55 within the cartridge 40 to allow for disbursement of a fluid to a user's skin during shaving. In a certain embodiment the disposal point 55 is a manifold. The manifold may be capable of delivering the fluid at a single point or multiple, evenly distributed points along at least a portion of a length of the blades 45. The manifold may be disposed in a position relative to the blades, said position selected from the group consisting of before the blade, after the blade, or a combination thereof.

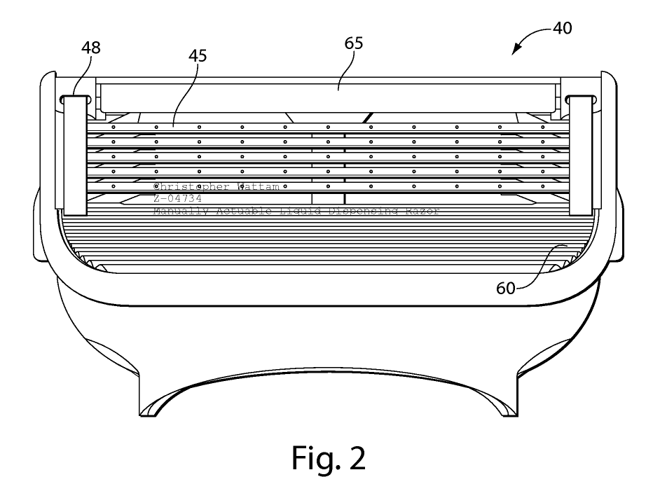

In FIG. 2, the one or more razor blades 45 are sandwiched between a guard 60 and a lubricating strip 65. The guard is useful for stretching the skin's surface immediately prior to engagement with the blade or a first blade (when more than one blade is present). This guard may typically comprise elastomeric material to allow for an engagement that is comfortable to a user. The lubricating strip, on the other hand, provides an additional treatment to the skin after contact between the fluid and the skin has occurred. The lubricating strip may contain the same or additional skin ingredients to those that are present in the fluid. Suitable lubricating strips are disclosed in U.S. Pat. No. 7,069,658 issued to Tseng et al. on Jul. 4, 2006, U.S. Pat. No. 6,944,952 issued on Sep. 20, 2005, U.S. Pat. No. 6,594,904 issued on Jul. 22, 2003, U.S. Pat. No. 6,182,365 issued to Tseng et al. on Feb. 6, 2001, US Design Patent D424745 issued to Tseng et al. on May 9, 2000, and U.S. Pat. No. 6,185,822 issued to Tseng et al. on Feb. 13, 2001, and U.S. Pat. No. 6,298,558 issued to Tseng on Oct. 9, 2001, and U.S. Pat. No. 5,113,585 issued to Rogers et al. on May 19, 1992.

Although not shown, a spreading medium may be placed below, above, or integral to the guard within the razor cartridge. The spreading medium may comprise a porous material selected from the group consisting of polyurethane, polyethylene, and combinations thereof. For instance, e.g., a sintered polyethylene material which is commercially available from Porex Technologies GmBH is suited for use herein. This porous material may be either hydrophilic or hydrophobic depending on the polarity of the fluid to be dispensed by the razor. Likewise, the average pore size of the material may range from about 1 micron to about 500 microns, from about 5 microns to about 300 microns, from about 5 microns to about 200 microns, from about 10 microns to about 150 microns, from about 10 microns to about 100 microns, from about 20 microns to about 60 microns, and from any specific lower limit to any specific upper limit within the broadest range mentioned herein. The spreading medium may be used in any shape or size that snugly fits in the razor cartridge in advance of the blade or blades. Also, in certain embodiments the spreading medium may extend substantially along a full length of the cartridge. In others, the medium may extend across only a central portion of the cartridge, either above or below the guard and/or blades.

In order to preserve the utility of the spreading medium, it is envisioned that a cover may be supplied prior to sale to the consumer for the medium to prevent inadvertent dehydration of the fluid to be dispensed from the razor. In a certain embodiment, the pump of the razor may be primed to pre-wet the spreading medium with the fluid or treatment composition prior to consumer use. Alternatively, such a cover could also be used by the end user to prevent dehydration of the fluid even after the initial priming of the pump when the shaving razor is used by the user for the first time.

FIG. 2 also shows clips 48 which are useful for retaining and maintaining the stability of the blade before, during, and after use of the razor.

The adapter head may be either permanently or removably joined to the handle. In the case where the adapter head is removable, the cavity may also be removably accessible or just accessible at the point of joinder between the handle and the head. In the instance where it is desired that the entire razor be deemed disposable, e.g., suitable for five or fewer uses, the handle and adapter head may be integrally formed with the cavity being filled with a fluid during manufacture or soon thereafter or at the very least prior to purchase by a user. In a certain embodiment, the adapter head may be pivotally connected to the razor cartridge to provide a larger range of shaving motion.

In a certain embodiment, the manually-actuated pump included in the adapter head may be a pump that included stacked (and substantially flat) components and particularly a movable wall that acts to activate the flow of fluid from the cavity through a cartridge feeding channel and to the disposal point. It is envisioned that there may be one or more disposal points along a portion of a length of the blade. This would translate into there being multiple cartridge feeding channels that originate from the cavity. For instance, there may be two, three, four, five, six, or more disposal points spaced equidistantly (or even randomly) along a portion of the length of the blade. Alternatively, there may be a multiplicity of disposal points that may occur over a multiplicity of blades in the instance where there is more than one blade.

A pump suitable for use in the present invention is disclosed in U.S. Pat. No. 5,993,180 issued to Westerhof on Nov. 30, 1999. In particular, this well-suited pump includes a pump chamber bounded by the movable wall, an inlet channel and an outlet channel, both of which are connected to the pump chamber, an inlet valve for closing the inlet channel, and an outlet valve for closing the outlet channel. The movable wall of the pump may take a number of forms. For instance, one movable wall embodiment may comprise a rigid topside that moves in the z-direction in response to a force acted upon the rigid topside that in turn causes non-rigid side walls of the pump to compress to move a fluid through the razor. In another instance of the present invention, the movable wall may comprise a rigid central region surrounded by a flexible periphery such that the movable wall's tactile characteristics vary within the single plane of the topside. In this instance the side walls may be either rigid or flexible. In another embodiment, the topside surface of the wall may be flexible such that the mere application of force to the flexible topside results in a “movable” wall that gives in response to such force. In most instances, the pump may be actuated by the pressure exerted by a user's finger such that the user may easily determine the requisite amount of fluid for one or more shaving strokes. Because the valves of the pump are automatically opened when pressure is applied by the user's finger pressure, the fluid can be dispensed in controlled and metered quantities without relying on judgment or dexterity of the user. It is also possible to place one or more movable walls of the pump on an upper surface or lower surface of the razor depending on a user's preference.

Another embodiment of the present invention may include a manually-actuated pump that is in the form of a liquid pump spray dispenser as is incorporated into various beauty care products, e.g., leave-hair conditioners, pump hair sprays, etc. It would be envisioned that such a pump would be disposed similarly within the handle as the movable wall pump shown in FIG. 1. This spray pump would also be manually operated by a user's finger or digit on an “as needed” basis according to a user's shaving routine.

There are a number of fluids that may be useful in the present razor. For instance, shaving gels, shaving foams, shaving lotions, skin treatment compositions, conditioning aids, etc. may be used to prepare the skin's surface prior to the engagement of the blade with the skin. Additionally, such materials may comprise benefit agents suitable for skin and/or hair that may be useful for a number of different desirable effects including exfoliation, cooling effects, cleansing, moisturization, warming or thermogenic effects, conditioning, and the like. Suitable benefit agents for skin and/or hair for inclusion into the fluid of the razor are disclosed in U.S. Pat. No. 6,789,321. For instance, suitable agents include but are not limited to shaving soaps, lubricants, skin conditioners, skin moisturizers, hair softeners, hair conditioners, fragrances, skin cleansers, bacterial or medical lotions, blood coagulants, anti-inflammatories, astrigents, and combinations thereof. In certain embodiments, the fluid may be contained in a sachet, either disposable or resusable, that is further contained within the cavity of the handle.

The razor cartridge of the present invention may be releasably engaged from the cartridge yoke and such elements are disclosed in U.S. Pat. Nos. D533684 S, 5,918,369, and 7,168,173 B2. This disengagement of these two components allows for replacement of razor cartridges as the continued use of such cartridges causes blade dulling. Thus, such cartridges are replaceable and disposable at will by the user. The yoke further comprises one or more arms that extend from the yoke and provide pivotal support of the yoke against the cartridge. The yoke may additionally comprise an ejection button to disengage the yoke from the cartridge to allow for simple replacement of the cartridge when blades have been dulled due to wear.

Another embodiment of the present invention merely relates to an implement that may be used in conjunction with a razor cartridge. This implement would consist of a handle including a proximal end and a distal end wherein the handle comprises a cavity; an adapter head joined to the handle at the proximal end wherein the adapter head has a proximal end and distal end and comprises 1) a manually-actuated pump placed between the proximal and distal ends of said head, 2) a cartridge connection yoke disposed at the proximal end of said head, and 3) an attached feeding channel wherein said cartridge connection yoke of said adapter head is equipped to releasably engage a razor cartridge and a cartridge feeding channel of said cartridge.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor suitable for dispensing a fluid during a shaving experience, said razor comprising:
a handle including a proximal end and a distal end wherein said handle comprises a cavity;
an adapter head joined to said handle at the proximal end wherein said adapter head comprises a manually-actuated pump and a cartridge connection yoke;
a razor cartridge comprising a blade and wherein a feeding channel is directed from said pump to a disposal point within said cartridge for dispensing said fluid; and
wherein said cartridge is releasably engaged with cartridge connection yoke of said adapter head.

2. The razor of claim 1 wherein said adapter head is permanently joined to said handle.

3. The razor of claim 1 wherein said adapter head is removably joined to said handle.

4. The razor of claim 3 wherein said cavity is removably accessible at a joinder of said head and said handle.

5. The razor of claim 1 wherein said adapter head and said handle are integrally formed.

6. The razor of claim 1 wherein said adapter head is pivotally connected to said cartridge.

7. The razor of claim 1 wherein said cartridge further comprises a guard.

8. The razor of claim 1 wherein said cartridge further comprises a lubricating strip.

9. The razor of claim 1 wherein at least one arm extends from said cartridge connection yoke to releasably engage said cartridge from said adapter head.

10. The razor of claim 1 wherein a manifold is disposed in a position relative to the blades, said position selected from the group consisting of before the blade, after the blade, or a combination thereof and said manifold serves as said disposal point.

11. The razor of claim 1 wherein said pump comprises a movable wall upon which force is acted upon to move a fluid through the feeding channel to said disposal point.

12. The razor of claim 10 wherein said movable wall is located on one or more of an upper or lower surface of said razor.

13. The razor of claim 1 wherein said cavity comprises a sachet of fluid.

14. The razor of claim 1 wherein said handle comprises a removable end cap at said distal end.

15. The razor of claim 1 wherein said the pump comprises a rigid wall upon which force is acted upon to cause the movement of non-rigid sidewalls of said pump to move a fluid through the feeding channel to the disposal point.

16. The razor of claim 1 wherein said razor cartridge is replaceable.

17. The razor of claim 1 wherein said disposal point runs along a length of said blade.

18. An implement comprising:
a handle including a proximal end and a distal end wherein said handle comprises a cavity;
an adapter head joined to said handle at the proximal end wherein said adapter head has a proximal end and distal end and comprises
a manually-actuated pump placed between the proximal and distal ends of said head,
a cartridge connection yoke disposed at the proximal end of said head, and an attached feeding channel
wherein said cartridge connection yoke of said adapter head is equipped to releasably engage a razor cartridge and a cartridge feeding channel of said cartridge.
